(19) United States
(12) Patent Application Publication
(10) Pub. No.: US 2008/0112271 A1
(43) Pub. Date: May 15, 2008

(54) TIME PROJECTION CLOCK

(75) Inventor: Raymond CHAN, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: IDT-LCD HOLDINGS (BVI) LIMITED, Hunghom (HK)

(21) Appl. No.: 11/558,054

(22) Filed: Nov. 9, 2006

(51) Int. Cl. G04C 17/00

(52) U.S. Cl. 368/30; 368/83

(57) ABSTRACT

A time projection clock comprises an operating circuit including a clock circuit for time keeping and producing a time signal, and a projection unit incorporating a projection circuit for receiving the time signal from the clock circuit and, in response, projecting a corresponding time image onto an external surface, based on the time signal. The projection circuit comprises a super-bright LED for emitting a light beam, a driver for driving the super-bright LED, and an LCD panel located in front of the super-bright LED and intersected by the light beam to produce the time image.

The present invention relates to a time projection clock.

### BACKGROUND OF THE INVENTION

Time projection clocks are known to include an LCD projector for projecting a time image upon a surface such as a bedroom ceiling. It can be difficult to read the time image especially at daytime.

The invention seeks to obviate or at least alleviate such a problem or shortcoming by providing an improved time projection clock.

### SUMMARY OF THE INVENTION

According to a first aspect of the invention, there is provided a time projection clock comprising an operating circuit including a clock circuit for time keeping and producing a time signal, and a projection unit incorporating a projection circuit for receiving said time signal from the clock circuit and then projecting a corresponding time image onto an external surface based on the time signal. The projection circuit comprises a super-bright LED for emitting a bright light beam, a driver for driving the super-bright LED, and an LCD panel located in front of the super-bright LED for interception by said light beam to produce said time image.

In a preferred embodiment, the time projection clock includes a main unit which houses the operating circuit and supports the projection unit.

More preferably, the main unit and the projection unit have separate upright housings, and the projection unit housing is pivotably connected alongside the main unit housing for pivotal movement relative to the main unit housing.

Further more preferably, the projection unit housing is pivotably connected to the main unit housing at mid-height height for pivotal movement relative to the main unit housing about a horizontal axis.

Yet further more preferably, the projection unit housing is pivotable relative to the main unit housing through an angle of 90° forward and 90° rearward.

In a preferred embodiment, the projection circuit is associated with a light sensor for sensing the ambient light level and then controlling the driver to drive the super-bright LED to emit said light beam at an intensity such that said time image is optimally visible in the ambient light condition.

More preferably, the driver operatively drives the super-bright LED to emit said light beam at predetermined high and low intensities to suit bright and dark ambient light conditions respectively sensed by the light sensor.

More preferably, the light sensor comprises a cadmium sulfide photo resistor.

In a preferred embodiment, the time projection clock includes a display controlled by the operating circuit for displaying time in situ based on said time signal.

More preferably, the operating circuit operatively controls the display to display time in a plurality of display modes, and the operating circuit includes a motion sensor for sensing motion of an object in front of the motion sensor to change the display mode from one to another.

Further more preferably, the display modes comprise at least a time display mode and a date display mode which are operatively switched by the operating circuit upon the motion sensor sensing motion of an object in front of the motion sensor.

Further more preferably, the motion sensor comprises an infrared transmitter and receiver.

According to a second aspect of the invention, there is provided a time projection clock comprising an operating circuit including a clock circuit for time keeping and producing a time signal, a display controlled by the operating circuit for displaying time in situ based on said time signal, and a projection unit incorporating a projection circuit for receiving said time signal from the clock circuit and then projecting a corresponding time image onto an external surface based on the time signal. The operating circuit operatively controls the display to display time in a plurality of display modes. The operating circuit includes a motion sensor for sensing motion of an object in front of the motion sensor to change the display mode from one to another.

### BRIEF DESCRIPTION OF DRAWINGS

The invention will now be more particularly described, by way of example only, with reference to the accompanying drawings, in which:

FIG. 1 is a front view of an embodiment of a time projection clock in accordance with the invention;

FIG. 2 is a top plan view of the time projection clock of FIG. 1;

FIG. 3 is a left side view of the time projection clock of FIG. 1;

FIG. 4 is a rear view of the time projection clock of FIG. 1;

FIG. 5 is a bottom plan view of the time projection clock of FIG. 1; and

FIG. 6 is a schematic functional block diagram of the time projection clock of FIG. 1.

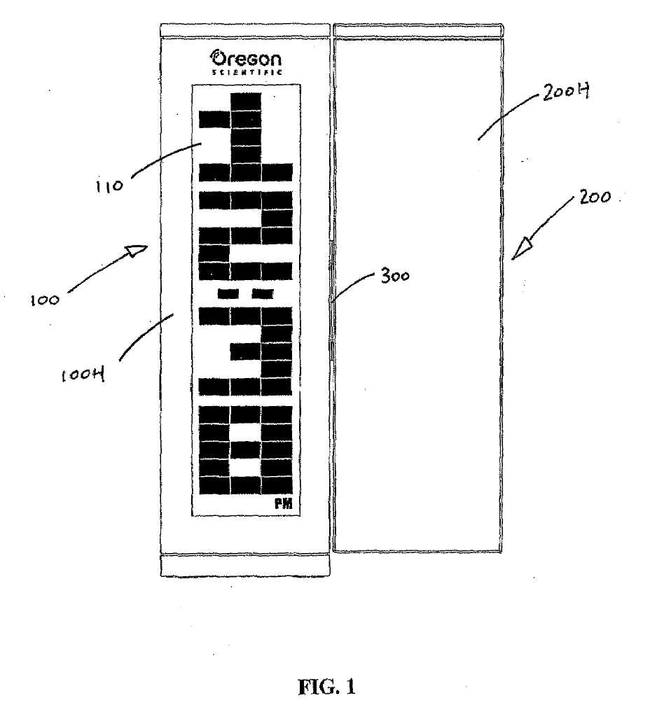

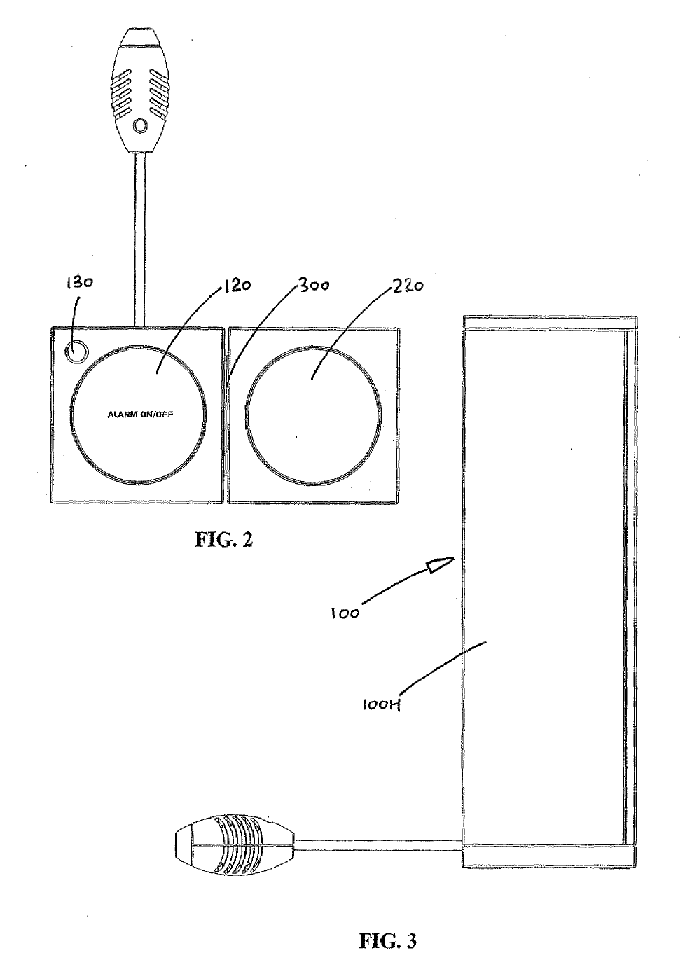

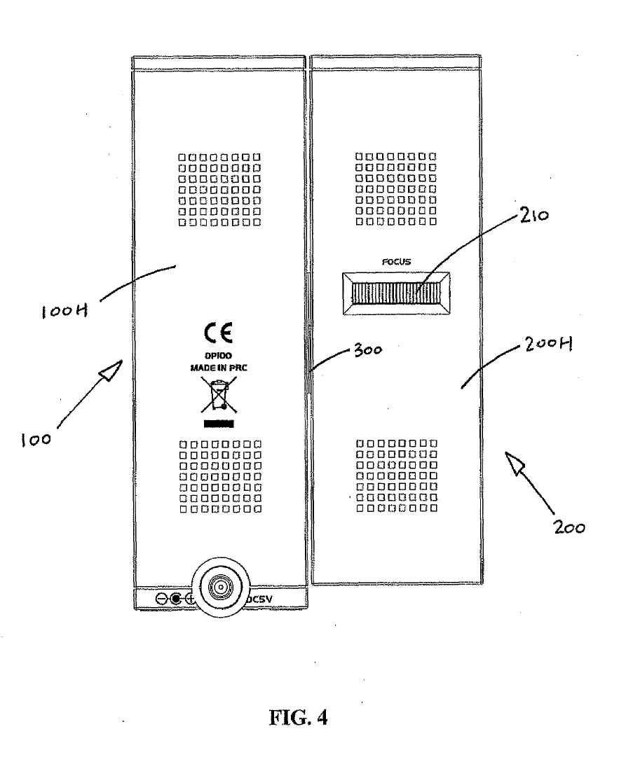

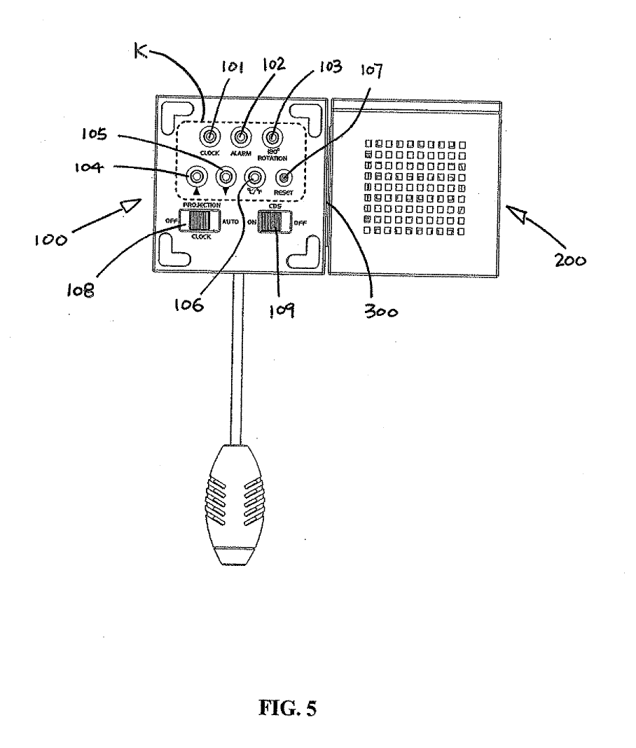

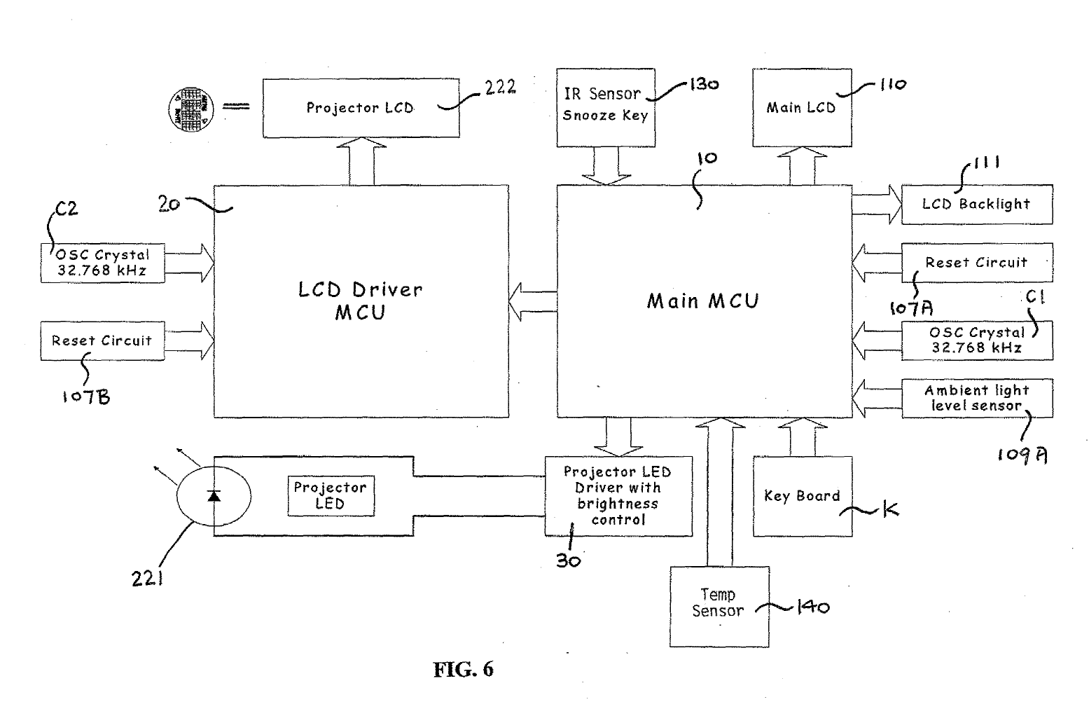

### DETAILED DESCRIPTION OF PREFERRED EMBODIMENT

Referring to the drawings, there is shown a time projection clock embodying the invention for desktop use, which comprises a main unit 100 and a projection unit 200 controlled by the main unit 100 to project time, etc. The main unit 100 and the projection unit 200 have separate upright oblong housings 100H and 200H. The projection unit housing 200H is pivotably connected alongside the main unit housing 100H by a hinge connection 300 at about mid-height for pivotal movement relative to the main unit housing 100H, about a horizontal axis of the hinge 300 through an angle of 90° forward and 90° rearward, to adjust the projection angle as required.

The main unit 100 houses an operating circuit which is built based on a main MCU (microprocessor control unit) 10 for general control and operations. The main MCU 10 includes a clock circuit for time keeping and related functions including time alarms and date (calendar) keeping for example, and it provides a time/date signal in operation. The main MCU 10 is connected with an oscillation crystal C1 for a requisite IC clock signal and also a reset circuit 107A. The main unit housing 100H has a main LCD display 110 on its front side, which is controlled by the main MCU 10 and illuminated by a LCD backlight 111 for displaying time in situ based on the time signal.

A internal temperature sensor 140 of the main unit 100 measures the indoor temperature in the range from 0° C. to +50° C. (32° F. to +122° F.) and provides the measured data to the main MCU 10 for displaying the indoor temperature on the LCD display 110, and also for projection display.

An alarm on/off button 120 (for enabling/disabling the alarm function or turning off an alarm) and a motion sensor 130 are situated at the top panel of the main unit housing 100H. A keyboard K formed by seven press keys 101 to 107 and two slide switches 108 and 109 are provided at the bottom panel for user control and setting.

The projection unit 200, which is supported by the main unit 100, houses a projection circuit for receiving the time signal from the clock circuit (i.e. the main MCU 10) and then projecting a corresponding time image onto an external surface, such as a bedroom ceiling or wall, based on the time signal.

The projection circuit incorporates a super-bright LED 221 for emitting a bright light beam in red color, and a miniature transparent digital time LCD panel 222 located in front of the LED 221 for interception by the light beam to produce the time image. There is a convex lens 220 located within the top end of the projection unit housing 200H for focusing the light beam to produce a sharp image, whose position is adjustable by a knurled turning knob 210 exposed on the rear side of the housing 200H.

Included in the projection circuit are an LCD driver MCU 20 for operating the LCD panel 222 and an LED driver circuit 30 for driving the super-bright LED 221. The LCD driver MCU 20 is connected to the main MCU 10 for control and in particular receiving the aforesaid time signal from the main MCU 10 to indicate time. The LED driver circuit 30 is also connected to the main MCU 10 for control, including brightness control. The LCD driver MCU 20 is connected with an oscillation crystal C2 for an IC clock signal and also a reset circuit 107B.

The projection circuit is associated with a light sensor 109A which is which implemented by a cadmium sulfide (CDs) photo resistor and is connected to the main MCU 10 for sensing the ambient light level to automatically control the brightness of the super-bright LED 221. Via the main MCU 10, the light sensor 109A then controls the LED driver circuit 30 to drive the LED 221 to emit the time projecting light beam at an intensity such that the resulting time image is optimally visible (i.e. not too bright or dim) in the ambient light condition. In this regard, the LED driver circuit 30 is designed to drive the LED 221 to emit the light beam at two predetermined high and low intensities to suit bright (i.e. daytime) and dark (i.e. nighttime) ambient light conditions respectively as sensed by the light sensor 109A.

Referring to the LCD display 110, it is controlled by the main MCU 10 to operate in a plurality of display modes, namely for displaying clock (time), calendar (date), alarm and indoor temperature. Each of these display modes may either be static or feature one or more animations, for example the data being shown gradually on the display 110 with its digits appearing sequentially one after the next, or the digits are scrolled across the display 110.

The various display modes are selectable by a user by means of the motion sensor 130 (located at the top end of the main unit housing 100H). The motion sensor 130 is formed using an IR (infrared) transmitter and receiver, and it is positioned to face upwardly for sensing or detecting the motion of an object within 10 mm to 150 mm in front of the sensor 130, such as the user's fingers or a pen sweeping past the sensor 130. The object, or its motion, is sensed by the receiver detecting IR light emitted by the transmitter and reflected by the object.

When the motion sensor 130 detects the motion of an object, the main MCU 10 switches the display mode of the LCD display 110 from the current mode to the next, for example from displaying time to displaying date. The display modes for clock (time), calendar (date), alarm and indoor temperature are cycled in that order upon repeated triggers of the motion sensor 130.

While an alarm signal is being given, i.e. the alarm sets off, the motion sensor 130 may be used as a snooze key to activate a snooze function for, say, 8 minutes.

The projection unit 200, or the time projection function, may be activated or deactivated using the switch 108. In general, the switch 108 may be used to select three projection modes i.e. auto, clock or off. The projection unit 220 is activated for continuous operation when the switch 108 is used to enter the “projection auto” or “projection clock” mode, when a power adapter (5V DC) is connected to the main unit 100. In the “projection auto” mode, the projected image toggles between current time and indoor temperature (with 10 second randomly animation for current time and 5 second for indoor temperature). Only the current time will be projected in the “projection clock” mode. In either case, an alarm icon is shown if an alarm is set. While the projection unit 200 is on, the light sensor 109A may be enabled/disabled using the other switch 109 to turn on/off the automatic brightness function.

It is envisaged that super-bright LEDs of different colors may be used in other embodiments of the subject projection clock for technical or aesthetic reasons, such as white, blue, green, yellow or orange, etc., or even the red/green/blue tri-color type.

The invention has been given by way of example only, and various other modifications of and/or alterations to the described embodiment may be made by persons skilled in the art without departing from the scope of the invention as specified in the appended claims.

1. A time projection clock comprising:
an operating circuit including a clock circuit for time keeping and producing a time signal; and
a projection unit incorporating a projection circuit for receiving time signal from the clock circuit and, in response, projecting a corresponding time image onto an external surface, based on time signal, wherein the projection circuit comprises
a super-bright LED for emitting a bright light beam,
a driver for driving the super-bright LED, and
an LCD panel located in front of the super-bright LED and intersected by the light beam to produce the time image.

2. The time projection clock as claimed in claim 1, including a main unit which houses the operating circuit and supports the projection unit.

3. The time projection clock as claimed in claim 2, wherein the main unit and the projection unit have separate upright main unit and projection unit housings, and the projection unit housing is pivotably connected alongside the main unit housing for pivotal movement relative to the main unit housing.

4. The time projection clock as claimed in claim 3, wherein the projection unit housing is pivotably connected to the main unit housing at mid-height for pivotal movement relative to the main unit housing about an axis.

5. The time projection clock as claimed in claim 4, wherein the projection unit housing is pivotable relative to the main unit housing through an angle of 90° forward and 90° rearward.

6. The time projection clock as claimed in claim 1, including a light sensor associated with the projection circuit for sensing ambient light level and, in response, controlling the driver to drive the super-bright LED to emit the light beam at an intensity such that the time image is visible in the ambient light level.

7. The time projection clock as claimed in claim 6, wherein the driver operatively drives the super-bright LED to emit the light beam at predetermined high and low intensities to respond to bright and dark ambient light conditions respectively sensed by the light sensor.

8. The time projection clock as claimed in claim 6, wherein the light sensor comprises a cadmium sulfide photo resistor.

9. The time projection clock as claimed in claim 1, including a display controlled by the operating circuit for displaying time in the projection clock based on the time signal.

10. The time projection clock as claimed in claim 9, wherein
the operating circuit operatively controls the display to display time in a plurality of display modes,
the operating circuit includes a motion sensor for sensing motion of an object and
the operating circuit changes the display mode from one display mode to another display mode in response to sensing of motion of an object by the motion sensor.

11. The time projection clock as claimed in claim 10, wherein the display modes comprise at least a time display mode and a date display mode which are operatively switched by the operating circuit in response to sensing of motion of an object by the motion sensor.

12. The time projection clock as claimed in claim 10, wherein the motion sensor comprises an infrared transmitter and receiver.

13. A time projection clock comprising:
an operating circuit including a clock circuit for time keeping and producing a time signal;
a display controlled by the operating circuit for displaying time in the projection clock based on the time signal; and
a projection unit incorporating a projection circuit for receiving the time signal from the clock circuit and, in response projecting a corresponding time image onto an external surface, based on the time signal, wherein
the operating circuit operatively controls the display to display time in a plurality of display modes,
the operating circuit includes a motion sensor for sensing motion of an object, and
the operating circuit changes the display mode from one display mode to another display mode in response to sensing of motion of an object by the motion sensor.
